(19) United States
(12) Patent Application Publication
(10) Pub. No.: US 2026/0208565 A1
(43) Pub. Date: Jul. 23, 2026

(54) WINDOW UNIT, MOLD AND ASSOCIATED METHODS

(71) Applicant: AGC GLASS EUROPE, Louvain-la-Neuve (BE)

(72) Inventor: Frank BEKAERT, Gosselies (BE)

(73) Assignee: AGC GLASS EUROPE, Louvain-la-Neuve (BE)

(21) Appl. No.: 19/104,825

(22) PCT Filed: Oct. 2, 2023
(86) PCT No.: PCT/EP2023/077269

§ 371 Date: Feb. 19, 2025

(30) Foreign Application Priority Data
Oct. 19, 2022 (EP) 22202374.9

(51) Int. Cl. B60J 1/00; B60J 1/20; B60R 13/04

(52) U.S. Cl. CPC B60J 1/001; B60J 1/20; B60R 13/04

(57) ABSTRACT

A window unit with a glazing panel, a frame profile provided on a part of the edge of the glazing panel on one peripheral side. The frame profile has a rigid part that receives a decorative strip. The rigid part is elongated with a long side along the at least one peripheral side and has at least one rigid and one flexible connection. The rigid and flexible connection means have elongated shapes with a long side along the peripheral side and the means are an integral part of the rigid part. The decorative strip has at least one first clamping part rotatably connected to the rigid connection means and at least one second clamping part to be clamped to the flexible connection means. The flexible connection means is totally offset from the rigid connection means in the direction of the rigid part's long side, by a distance greater than 0 mm.

### TECHNICAL FIELD

The present invention relates to an automotive window unit comprising a glazing panel, a decorative strip and a frame profile on at least one part of a peripheral side of the edge of an automotive window unit. The invention relates also to a method of producing a window unit provided with a decorative strip and to the corresponding mold.

### BACKGROUND ART

Window units with a glazing panel and a frame are known. The window units are often equipped with decorative strips to enhance the visible aspect of the window. Generally, decorative strips are made of metallic or plastic materials and are fixed to the glazing by different means such as: glue, bending of the decorative strip in specific area (harpoon), metallic fixations integrated to the frame or overmolding of the strip during an encapsulation process.

Today, some window units have a frame that is provided around the glazing unit by encapsulation with a soft material and a decorative strip is fixed to the glazing panel with metallic fixation such as metallic clips as described in DE19818153. These metallic clips are fixed manually on the encapsulated frame before the decorative strip assembly. However, this kind of manufacturing is manpower consuming and increase the cost of the window manufacturing.

Plastics inserts have been developed for supporting decorative strips, to avoid high thickness of the encapsulated material and to meet the current expectations of high surface quality of the window unit. Further to the role of supporting the decorative strip, plastics insert is also used to increase the rigidity of the glazing unit in some specific area like rear corner. The use of such insert allows also a cycle time reduction of the process of manufacturing due to higher cooling speed after injection of the material for encapsulation.

Several process routes have been proposed in the art to easily fix a decorative strop to an insert: Patent application CN102272463A discloses an insert for fixing a decorative strip on a moulding frame. The insert comprises at least one clamp having at least an upstream mating portion that cooperates with the molding frame and a downstream mating portion that allows mating with the attachment accessory, the upstream mating portion includes a plurality of hook feet connected by a base, the extremity of each foot is deformable. However, the insert has multiple hooking feet and complicated shape, making its own manufacturing process and its installation process highly complex. WO2022/029000 proposes a simpler production and fixation of a decorative strip by designing the rigid part of the frame to comprise a snap-fit system which comprises one rigid arm and one flexible arm. CN114750707 discloses a system to fix a decorative strip to an insert including a mounting part, a fixed part and a flexible part wherein the decorative strip includes a first clamping part to be rotatably connected to the mounting part and a second clamping part to be fixed to the flexible part.

However, the molding process of the plastic insert with rotating and flexible connections is very challenging, in particular in view of the decorative strips that are becoming thinner and thinner. Hence, there is still a need in the art to design a plastic insert that allows a simplified, sustainable and cost effective molding process.

### SUMMARY OF INVENTION

The present invention relates to a window unit comprising a glazing panel, a frame profile provided on at least a part of the edge of the glazing panel on at least one peripheral side and comprising a rigid part designed to receive a decorative strip. The rigid part has an elongated shape with a long side along the at least one peripheral side, and comprises at least a one rigid connection means and at least one flexible connection means. The at least one rigid connection means and the at least one flexible connection means have an elongated shape with a long side along the at least one peripheral side and are an integral part of the rigid part. The window unit further comprises a decorative strip that comprises at least one first clamping part to be rotatably connected to the at least one rigid connection means and at least one second clamping part to be clamped to the at least one flexible connection means. The at least one flexible connection means is totally offset from the at least one rigid connection means in the direction of the long side of the rigid part, by a distance greater than 0 mm (D>0mm), preferably equal to or greater than 5 mm (D≥5mm), more preferably equal to or greater than mm (D≥10mm), most preferably equal to or greater than 15 mm (D≥15mm). The frame profile can further comprise a soft part made of soft material, and being overmolded on at least a part of the rigid part.

In another embodiment, the present invention relates to a method for producing such window unit, that includes an overmolding step of a rigid part provided on at least a part of the edge of the glazing panel on at least one peripheral side designed to receive a decorative strip, the rigid part comprising at least one rigid connection means and at least one flexible connection means.

In a further embodiment, the present invention relates to a mold to produce the rigid part of the above described window unit. The mold comprises a cavity to create by injection the rigid part that comprises the at least one rigid connection means and the at least one flexible connection means and wherein the at least one flexible connection means is totally offset from the at least one rigid connection means in the direction of the long side of the rigid part, by a distance greater than 0 mm (D>0mm).

### BRIEF DESCRIPTION OF THE DRAWINGS

The present invention will be described in more details below, with reference to the appended drawings showing various exemplifying embodiments of the invention which are provided by way of illustration and not of limitation. The drawings are a schematic representation and not true to scale. The drawings do not restrict the invention in any way.

FIG. 1 is a schematic 3D view of a window unit according to a first aspect of the invention.

FIG. 2 is a schematic 3D view of a window unit according to one embodiment of the invention, that further comprises a decorative strip.

FIG. 3 is an enlarged schematic 3D view of part of FIG. 1.

FIG. 4 is a schematic 2D view of FIG. 3.

FIG. 5A and FIG. 5B are schematic sectional views of the window unit of FIG. 4 along plane AA′.

FIG. 6A and FIG. 6B are schematic sectional views of the window unit of FIG. 4 along plane BB′.

FIG. 7 is a schematic 3D view of a decorative strip.

### DETAILED DESCRIPTION

In this document to a specific embodiment and include various changes, equivalents, and/or replacements of a corresponding embodiment. The same reference numbers are used throughout the drawings to refer to the same or like parts. Other variations can be envisaged within the scope of the claims.

As used herein, spatial or directional terms, such as “inner”, “outer”, “above”, “below”, “top”, “bottom”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, processing parameters, quantities of ingredients, reaction conditions, and the like, used in the specification and claims are to be understood as being modified in all instances by the term “about”. Accordingly, unless indicated to the contrary, the numerical values set forth in the following specification and claims are approximations that can vary depending upon the desired properties sought to be obtained by the present invention. In the following description, unless otherwise specified, expression “substantially” mean to within 10%, preferably to within 5%.

Moreover, all ranges disclosed herein are to be understood to be inclusive of the beginning and ending range values and to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Further, as used herein, the terms “deposited over” or “provided over” mean deposited or provided on but not necessarily in surface contact with. For example, a coating “deposited over” a substrate does not preclude the presence of one or more other coating films of the same or different composition located between the deposited coating and the substrate.

Where the term “comprising” is used in the present description and claims, it does not exclude other elements or steps. Where an indefinite or definite article is used when referring to a singular noun e.g. “a” or “an”, “the”, this includes a plural of that noun unless something else is specifically stated. In this document, “configured to (or set to)” may be interchangeably used in hardware and software with, for example, “appropriate to”, “having a capability to”, “changed to”, “made to”, “capable of”, or “designed to” according to a situation. In any situation, an expression “device configured to do” may mean that the device “can do” together with another device or component.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated. herein. When it is described that a constituent element (e.g., a first constituent element) is “(functionally or communicatively) coupled to” or is “connected to” another constituent element (e.g., a second constituent element), it should be understood that the constituent element may be directly connected to the another constituent element or may be connected to the another constituent element through another constituent element (e.g., a third constituent element).

### Window unit

The present invention relates to a window unit that comprises a glazing panel, a frame profile that comprises an rigid part and optionally a soft part, and a decorative strip wherein the decorative strip is fixed to the rigid part via a rotative connection and a flexible connection. The object of the present invention is to design the rigid part so that it can perform its function of efficiently fixing the decorative strip while allowing the corresponding injection mold of the rigid part to be robust and hence sustainable and to provide a molding process which is simple and cost effective.

Rotative connections means are very efficient to guide the fixing of and to fix the decorative strip to the rigid part. Flexible connections are also known to be very effective connection means. Especially when made as an integral part of the rigid part, as for the present invention, it simplifies greatly the production process. However, the design of such flexible connection means-when made of hard thermoplastic material, requires certain space to provide the required flexibility. Moreover, current trend in the car industry is to design decorative strips that become thinner and thinner and therefore offer less and less space for the connection means to the rigid part of the window assembly. It has been surprisingly found that designing the rigid part comprising at least one rotative rigid connection means and at least one flexible connection means such that the rigid connection means and the flexible connection means are shifted from each other, allows to take advantage of the efficiency of both connection means even for thin decorative strips. Such design allows the corresponding mold of the rigid part to be robust and therefore sustainable. Hence, such design of the rigid part provides very effective connection of decorative strip to the rigid part, robust mold and simple, cost effective and sustainable production process.

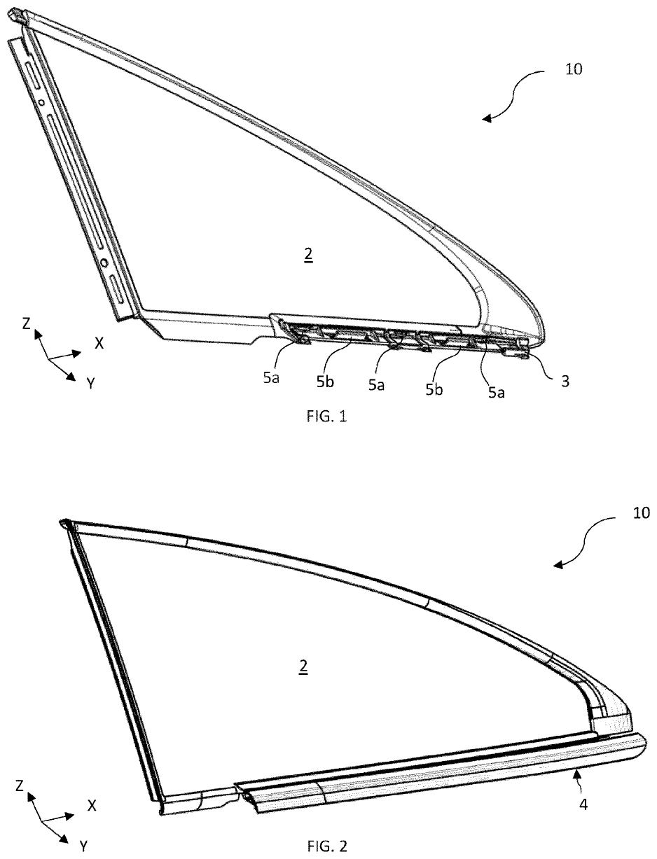

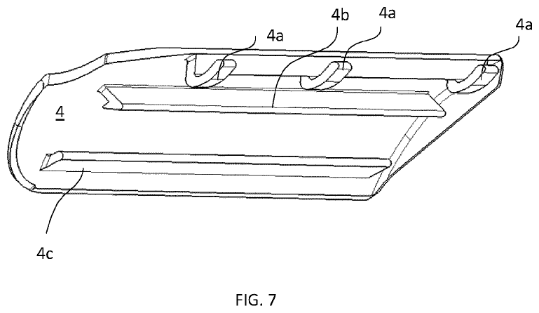

As illustrated in FIG. 1 and FIG. 2, in a first aspect, the present invention relates to a window unit (10) comprising a glazing panel (2), a frame profile comprising a rigid part (3) that is designed to receive a decorative strip (4). The frame profile is provided on at least a part of the edge of the glazing panel on at least one peripheral side. The rigid part has an elongated shape with a long side along the at least one peripheral side. It comprises at least a one rigid connection means (5a) and at least one flexible connection means (5b); both means have an elongated shape with a long side along the at least one peripheral side. As illustrated in FIG. 7, the decorative strip (4) comprises at least one first clamping part (4a) to be rotatably connected to the at least one rigid connection means (5a) and at least one second clamping part (4b) to be clamped to the at least one flexible connection means (5b).

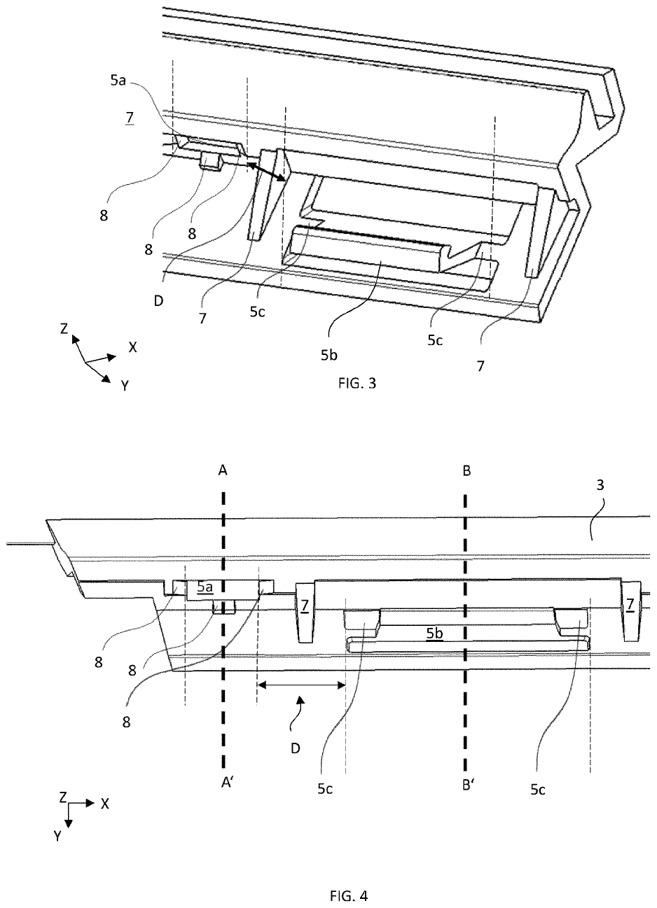

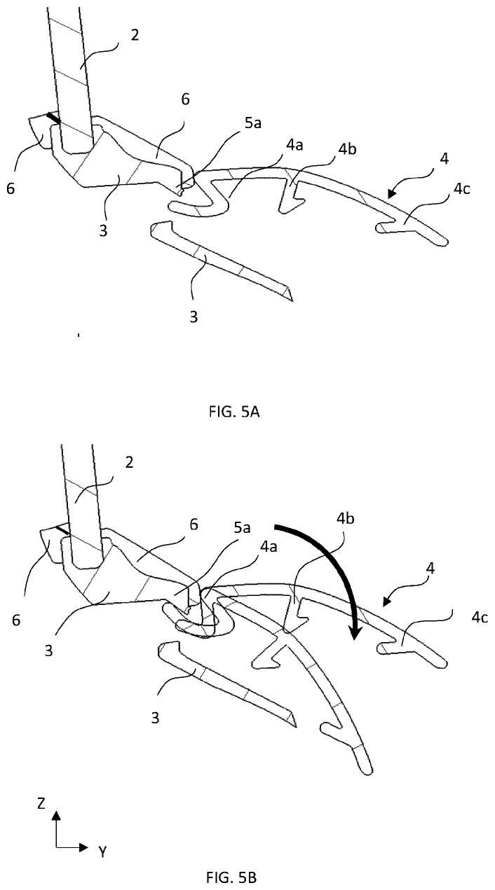

In the window unit of the present invention, the at least one flexible connection means is totally offset from the at least one rigid connection means in the direction of the long side of the rigid part, by a distance greater than 0 mm (D>0mm) as illustrated in FIG. 3 and FIG. 4.

### Glazing Panel

The glazing panel (2) can comprise at least one glass sheet. In another embodiment, due to reduction of induced deformations on the glazing panel, the glazing panel can comprise a laminated glass panel. The laminated glass panel comprises glass sheets maintained by one or more interlayers positioned between glass sheets. The interlayers employed are typically polyvinyl butyral (PVB) or ethylene-vinyl acetate (EVA) for which the stiffness can be tuned. These interlayers keep the glass sheets bonded together even when broken in such a way that they prevent the glass from breaking up into large sharp pieces. It could also be advantageous to have varying thicknesses of glass sheets to reduce weight and noise. Due to induced deformations on the glazing panel, thin glass sheets with a thickness less than 1 mm can be used without being bent or deformed. Thus, such thin glass sheet can keep the desired design.

The shape of the window unit in a plan view (in the X-Z plane) is usually a triangle, especially for a window unit used as a quarterlight window unit. Depending of the application, the shape is not limited to a triangle and may be a rectangle, a trapeze, a circular-shape, a hex or the like.

The glazing panel can be a flat or curved panel to fit with the design of the car. The glazing panel can be processed, ie annealed, tempered, . . . to respect with the specifications of security and anti-thief requirements. A heatable system, for example a coating or a network of wires, can be applied on the glazing panel to add a defrosting and/or a demisting function for example.

The material of the glass sheet can independently be, for example, soda-lime silica glass, borosilicate glass, aluminosilicate glass or other materials such as thermoplastic polymers or polycarbonates which are especially known for automotive applications. References to glass throughout this application should not be regarded as limiting. The glass sheet can independently be a clear glass or a coloured glass, tinted with a specific composition of the glass or by applying a decorative coating, paint or a plastic layer for example. The glass sheet can independently be manufactured by a known manufacturing method such as a float method, a fusion method, a redraw method, a press molding method, or a pulling method. As a manufacturing method of the glass sheet, from the viewpoint of productivity and cost, it is preferable to use the float method.

### Window Frame—Rigid Part

According to the invention, the window unit comprise a frame profile provided on at least a part of the edge of the glazing panel on at least one peripheral side, that comprises a rigid part designed to receive a decorative strip. The rigid part has an elongated shape with a long side along the at least one peripheral side.

It is understood that the rigid part is typically made of a hard thermoplastic material with a young modulus higher than 1000 MPa, preferably with a young modulus higher than 1500 MPa. In a preferred embodiment, the rigid part is a polypropylene based material. Other hard materials, with a young modulus higher than 1000 MPa, as polyamide, specific styrenic, ABS, specific PVC and others can be also used.

In some preferred embodiments, the rigid part can be reinforced with fillers (glass fibres, glass beads, calcium carbonate, talc, silica, wollastonite, clay, calcium sulphate fibres, mica), i.e. a polypropylene reinforced with 30% of glass fibers (PP 30GF) having a young modulus higher than 1500 MPa, about 1680 MPa.

In one embodiment of the invention, the rigid part is in direct contact with the glazing panel meaning that the rigid part is injected onto the glazing panel directly without any other material between the primary part and the surface of the glazing panel. The glazing panel can have locally a bonding agent or primer material to ensure tightness and/or to promote the encapsulation of the rigid part onto the glazing panel.

The rigid part can be overmolded on the glazing panel. To facilitate the process, the rigid part is preferably injected into a mold to be encapsulated on the glazing panel. The rigid part can have a specific shape to fulfil with the requirement of the desired application. In some embodiments, the rigid part can have extensions to ensure the mechanical strength of the window unit.

### Connection Means

In the window unit of the present invention and as illustrated in FIG. 1, the rigid part comprises at least a one rigid connection means (5a) and at least one flexible connection means (5b). The at least one rigid connection means and the at least one flexible connection means have an elongated shape with a long side along the at least one peripheral side. The at least one rigid connection means and the at least one flexible connection means are an integral part of the rigid part, i.e. the rigid connection means, the flexible connection means and rigid part are made in a single part. Therefore, they are made from the same material and during a single step.

In the present invention, the at least one flexible connection means is totally offset from the at least one rigid connection means in the direction of the long side of the rigid part, by a distance greater than 0 mm (D>0mm). Each connection means has a long side along the at least one peripheral side and has edges normal to that direction. As illustrated in FIG. 3 and FIG. 4, the distance D is measured between the edge of the at least one flexible connection means to the edge of the closest adjacent rigid connection means.

In a preferred embodiment of the present invention, the distance is equal to or greater than 5 mm (D≥5mm), preferably equal to or greater than 10 mm (D≥10mm), more preferably equal to or greater than 15 mm (D≥15mm). Preferably, the distance is lower than or equal to 25 mm (D≤25mm), more preferably lower than or equal to 20 mm (D≤20mm).

It has been found that such offset provides the required molding space necessary to mold both connection means, in particular to provide the required molding space to mold the flexible connection means. It has been surprisingly found indeed that when the design of the decorative strip is such that its width is so narrow than there is not enough space to position proper one snap-fit system, a quick and efficient fixation of the decorative strip can nevertheless achieved by providing a rigid part with spaced apart rigid connection means for rotative connection and flexible connection means for clamping. The width of the decorative strip is measured in the direction normal to the elongated side. The distance between the at least one rigid connection means and the at least one flexible connection means is required to provide enough space for the necessary injection processing sliding block and/or injection ports. In a further preferred embodiment, the rigid part is designed to accept injections ports that allow molding of the rigid part—without sliding block, to provide even more robust and sustainable mold, lower production costs and lower maintenance costs.

The rigid part can typically comprise more than one rigid connection means and more than one flexible means. Typically, the number of rigid connection means equals the number of flexible connection means and typically they alternate along the long side of the rigid part.

It can be contemplated in other embodiments of the present invention that there are more rigid connection means than flexible connection means or that there are more flexible connection means than rigid connection means. It can be contemplated as well that several rigid connection means are adjacent to each other and/or several flexible connection means are adjacent to each other. The number and their location will depend on the type as well the shape and the material of decorative strip. FIG. 1 illustrates an embodiment wherein the rigid part does not comprises the same number of rigid and flexible connection means, i.e. three rigid connection means and two flexible connection means.

In the embodiment of the present invention wherein the rigid part comprise more than one rigid connection means and more than one flexible connection means, the distance D is measured, for each connection means, between each edge of flexible connection means to the edge of the closest adjacent rigid connection means. In some embodiments wherein the flexible connection means is not placed next to a rigid flexible means, such as for example next to another flexible connection means or close to the edge of the rigid part, the distance D is not measured.

In a preferred embodiment to enhance further the sustainability of the rigid part and of the corresponding mold, the rigid connection means and the flexible connection means are distributed along the length of the long side of the rigid part and are offset in the direction normal to the at least one peripheral side in order to provide the effective fixing of the decorative part. Indeed, the combination of one rigid connection means with its adjacent flexible connection means can typically be used to form two arms of a snap-fit system.

### Rigid Connexion Means

As illustrated in FIG. 3, FIG. 4, FIG. 5A and FIG. 5B, the rigid connection means (5a) comprise a support to enable the rotative connection of with a first clamping part (4a) of the decorative strip.

In a preferred embodiment and as depicted in FIG. 1, the rigid connection means are located on a substantially rectilinear line of the rigid part. More preferably the rigid connection means are located on a rectilinear line close to the glazing panel to guide the positioning of the decorative strip along the glazing panel and to perform the rotative fixation towards the car body. This is advantageous to avoid damages and scratches to the car body.

The rigid connection means allows to connect the decorative strip by rotation. The rotation axis of the decorative strip is substantially parallel to the long side of the rigid part. Typically, the first clamping part (4a) of the decorative strip, turns on a support that can be a bridge or rigid top support; an aperture, opening or slot; a niche, alcove, depression or nook; a cutout or any other means that performs the same function. In a preferred embodiment, the rigid connection means is a hole, preferably a hole of an overall rectangular shape.

### Flexible Connexion Means

To allow an assembly between the second clamping part of the decorative strip and the rigid part, some deformation of the flexible connection means is needed. The direction of the deformation is generally perpendicular to the direction of the long side of the rigid part. Suitable flexible connection means are described in patent application WO2022/029000 on page 4 and page 3 in reference to FIG. 3. As explained therein, for a given admissible strain ratio linked to the material used, the maximum deformation of the flexible arm, which allow the flexible arm to work in an elastic behaviour without risk of breakage, is directly proportional the elasticity factor. The elasticity factor is mainly independent of the material used, as it is a rigid material, but linked to the design of the flexible arm of the snap-fit system: the more elasticity factor is high, the more the flexible arm can move without risk of damage and with a correct spring back effect.

In some embodiments, the flexible connection means (5b) can have an arm designed to be flexible in a direction substantially perpendicular to the axis of penetration of a decorative strip to be plugged with the flexible connection means (5b). Since made of a rigid material such as Polypropylene, the shape, the length, the thickness and/or the width can vary depending on the application and on the decorative strip to be plugged. The flexible connection means can also comprises an end part. The end part can comprises a hook-like element to maintain a decorative strip once plugged into the flexible connection means (5b).

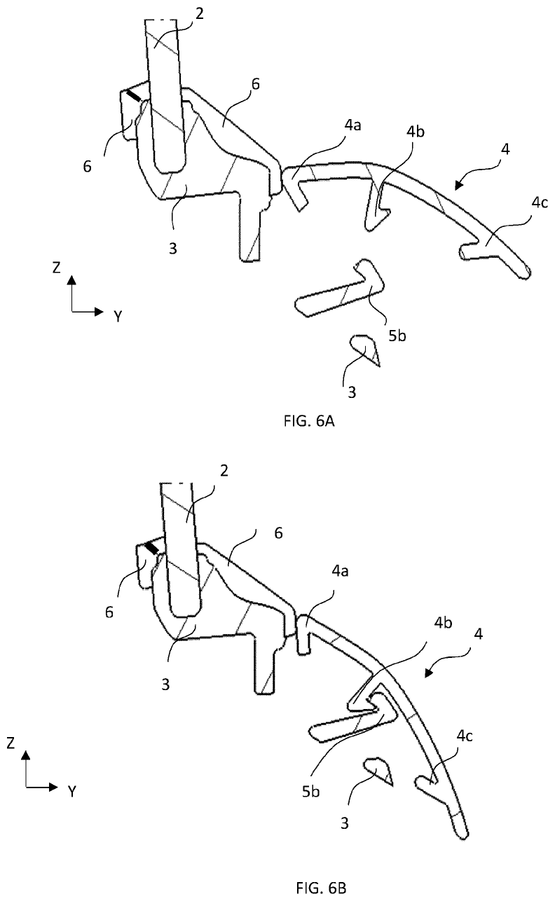

As illustrated in FIG. 3, FIG. 4, FIG. 6A and FIG. 6B, the flexible connection means (5b) preferably comprises an arm and a hook-like end part to enable the clamping to the second clamping part (4b) of the decorative strip.

According to one embodiment of the present invention, the flexible connection means has a elasticity factor higher than 30 mm. The elasticity factor is defined as the square of the average length of the arm divided by the average thickness of the arm.

To provide further elasticity to the flexible connection means and further robustness to the rigid part, it is preferred that the rigid part (3) further comprises torsion bars (5c) and typically a torsion bar on each side of the rigid connection means (5b). The torsion bar is connected between the rigid part and the flexible connection means as illustrated in FIG. 3 and FIG. 4. The torsion bar can be elastically deformed to drive the flexible connection means to rotate relative to the rigid part.

Therefore, the risk of breakage of the rigid part, being a brittle material, is reduced due to the requested deformation linked to the decorative strip assembly. This allows to proceed to a safe, quick and easy assembly of the decorative strip on the rigid part.

Furthermore, this combination of a rigid connection means with a flexible connection means allows also the removability of the decorative strip after assembly on the rigid part by use of a flat screw driver for example when the window assemble is not yet assembled in the car. This is advantageous since it allows quality check in the factory. Indeed, if an issue arises in production, it allows to unmount the decorative strip and to avoid scrapping the whole faulty window unit. The decorative strip cannot be removed after its assembly on the car. Allowing reworking by disassembling the decorative strip when the window unit is placed on the car would be an issue in term of safety and theft risk.

According to one embodiment of the present invention, one or more guide means can be integrated to the rigid part in order to better align the rigid part and the decorative trim by fitting of the guide means with the decorative trim rigid arms. The use of a guide means allows to insure correct assembly. Guide means can in some cases be integrated to the rigid part or more particularly to the rigid part and the decorative strip too. The function is to guide the decorative strip according to the rigid part and so insure an perfect alignment between both parts, which is then a guarantee of a high quality positioning of the decorative strip on the encapsulation of the frame profile.

Preferably, the rigid part will comprise guide means (8) close to the rigid connection means such as chamfers on the thickness of the edges of the rigid connection means and/or guide ramps as illustrated in FIG. 3 and FIG. 4.

As illustrated in FIG. 3 and FIG. 4, an additional advantage of the present invention wherein the at least one least one rigid connection means and the at least one flexible connection means are offset is that a reinforcement means (7) can be added between the rigid and flexible connection means, preferably along the edges of the flexible connection means, to provide an even more robust and therefore more sustainable rigid part.

### The Decorative Strip

In order to improve the overall appearance of the car, a decorative strip is provided on the portion of the edge of the automobile glazing panel (2) visible from the outside of the automobile as illustrated in FIG. 2. The decorative strip (4) is used to cover the automotive glazing panel edge Typically, the decorative strip (4) is used as an ornament on the part of the edge of the glazing panel (2) visible from the outside of the automobile. It is understood that the way of fixing the decorative strip (4) to the rigid part (3) may be also suitable for other decorative products or automobile glazing accessories. The decorative strip is generally an elongated element, substantially parallel to the edge of the glazing unit with a well finished exterior surface. The decorative strip can have any shape in order to mask the part of the window unit that should not be visible once mounted on a structure.

As illustrated in FIG. 7, the window unit of the present invention further comprises a decorative strip (4) comprising at least one first clamping part (4a) to be rotatably connected to the at least one rigid connection means (5a) and at least one second clamping part (4b) to be clamped to the at least one flexible connection means (5b). The second clamping part can be made of several discrete parts that corresponds to each flexible connection means of the rigid part and/or can made of more or less lengthy part(s) that run along the long side of the elongated shape of the decorative part. The embodiment illustrated in FIG. 7, shows three discrete first clamping parts (4a) and a single long second clamping part (4b).

FIG. 5A and FIG. 5B illustrate to rotative connection between the rigid part (3) and the decorative part (4). A first clamping part (4a) of the decorative strip is inserted within the rigid connection means (5a) and the decorative strip is pressed down to clamp the second clamping part (4b) of the decorative strip to the flexible means (5b) of the rigid part (3) as illustrated in FIG. 6A and FIG. 6B. In one embodiment, the decorative strip comprises several first clamping parts that are typically arranged at intervals. In this instance, the rigid part comprises several corresponding rigid connection means. Similarly, the decorative strip can comprise several second clamping parts that are typically arranged at intervals. In this instance, the rigid part comprises several corresponding flexible connection means.

As illustrated in FIG. 5A to FIG. 6B, the rotative direction of the first clamping part (4a) is preferably opposite to the bending direction of the second clamping part (4b), which facilitates the decorative strip being firmly fixed to the rigid part (3).

As illustrated in FIG. 7, the decorative strip (4) can further comprise a blocking strip (4c). The blocking strip is fixed on the edge of the decorative strip. When the decorative strip is snap-fitted to the rigid part (3), the blocking strip (4c) can reduce the matching gap formed by the decorative strip and the window unit to prevent environmental dust and the like entering in between. The blocking strip further allows to reduce the risk of scratches on the car body and to position properly the decorative strip on the rigid part and ensure proper alignment of the decorative strip on the car body.

The first clamping part (4a), the second clamping part (4b) and the blocking strip (4c)—when present, are fixed to the decorative strip (4) on the same side surface and spaced apart from each other for snap-fitting to the rigid part (3).

The decorative strip can be made of plastic-based material or a metal such as aluminium. It can have a coating, a film, or alike on the external surface for aesthetic reasons such as matching with the colour of the structure or giving a specific finish aspect.

### Frame Profile—Soft Part

As illustrated in FIG. 5A to FIG. 6B, in one embodiment of the invention, the frame profile of the widow unit further comprise a soft part (6) being made of soft material. The soft part is overmolded on at least a part of the rigid part. As described above, the rigid part is typically made a hard material. The frame profile allows to thigh the window unit on the structure where it is fixed. Such structure can be a car body, a building, . . .

The frame profile can be injected in a step, done after the step of injecting the rigid part, over at least partially the rigid part. Preferably, the frame profile is one single part. In some embodiments, the frame profile part can be locally in contact with the glazing panel to ensure the aesthetic and the tightness of the window unit.

According to one embodiment of the present invention, the frame profile encompassing the edge of the glazing panel on at least one peripheral side, is made of soft material which has a natural chemical cohesive bonding with the hard component of the rigid part. Thus, a good adhesion between the frame profile and the rigid part may be obtained without using a primer between them.

The soft component has a young modulus lower than 1000 MPa and can be made of thermoplastic elastomer based material. Styrenic based and vulcanized thermoplastics elastomer are generally used. The soft component is in another embodiment a soft polyvinyl chloride.

The soft component is used to give the final surface aspect of the frame and also to fit the window unit to the car body. Effectively, the softness of the material allow interferences between the carbody and the window unit by the use of soft lips. Soft component is sometimes also used to insure a sealing function between the car body and the encapsulated window unit.

### Process

Typically, the frame profile and the rigid part are injected at least partially on the glazing during an injection moulding process. Thus, the process of manufacturing the window unit according to the present invention is simplified.

In a further aspect, the present invention relates to a method for producing a window unit (10) as described herein wherein the method includes an overmolding step of a rigid part (3) provided on at least a part of the edge of the glazing panel (2) on at least one peripheral side designed to receive a decorative strip (4), the rigid part (3) comprising at least one rigid connection means (5a) and at least one flexible connection means (5b).

According to one embodiment of the present invention, the rigid part is first produced in a separate mould by injection moulding. It is can be stored before being overmolded with the frame profile made of a soft material in an encapsulation mould or cavity of a mold. According to such embodiment, the method for producing a window unit includes the following steps:
a) Injecting the rigid part in a separate mold. The rigid part comprises indeed the at least one rigid connection means and the at least one flexible connection means,
b) Placing a glazing and the rigid part in an encapsulation mold,
c) Encapsulating the soft part on at least one peripheral side of the glazing panel and overmolding the soft part on at least a part of the rigid part wherein the decorative strip is intended to be placed, to form an injected module,
d) Taking back the injected module from the encapsulation mold,
e) Assembling the decorative strip on the injected module by rotatably connecting a first clamping part of the decorative strip to the at least one rigid connection means of the rigid part and,
f) Clamping a second clamping part of the decorative strip to the at least one flexible connection means.

According to another one embodiment of the present invention, the rigid part is directly moulded by encapsulation on at least one peripheral side of the glazing panel and overmolded with the frame profile made of a soft material in an second encapsulation mould or cavity. This classical 2K process makes the process easier and reduces cost. According to this embodiment, the method includes the following steps:
a) Placing a glazing in a first encapsulation mould or cavity,
b) Encapsulating the rigid part on at least one peripheral side of the glazing panel wherein the decorative strip is intended to be placed. The rigid part comprises indeed the at least one rigid connection means and the at least one flexible connection means
c) Transferring the glazing and the rigid part so formed in a second encapsulation mould or cavity,
d) Overmolding at least a part of the rigid part by injection of the soft part and overmolding at least one peripheral side of the glazing panel by injection of the frame profile at the same time, to form an injected module,
e) Removing the injected module from the second encapsulation mould or cavity,
f) Assembling the decorative strip on the injected module by rotatably connecting a first clamping part of the decorative strip to the at least one rigid connection means of the rigid part and,
g) Clamping a second clamping part of the decorative strip to the to the at least one flexible connection means of the rigid part.

In this method, the rigid part provided with the at least one rigid connection means and at least one flexible connection means, is directly moulded on the glazing panel. In that case, a specific encapsulation mould is manufactured. The glazing panel is placed in this mould and the glazing panel is encapsulated directly with the hard material i.e. the rigid part. Later on, the module made of glazing panel and hard rigid part is placed in another mould or a cavity of the mould and then is overmolded with the soft material of the frame profile. The process of manufacturing a glazing panel provided with a frame profile and a rigid part intended to receive a decorative strip is simplified and reduce the manpower.

### Mold

The rigid part can be molded separately or can be molded directly on the glazing panel. Hence, in a further aspect, the present invention relates to a mold to produce the rigid part—or a window unit comprising the rigid part—that comprises, the flexible connection means and the rigid connection means. The mold comprises a cavity to create by an injection the rigid part. The mold comprises a top part and a bottom part. The parts can close up creating the cavity. The cavity is sealed once the parts are closed. The mold comprises at least one injection nozzle to inject into the cavity the rigid part.

When the rigid part is molded directly on the glazing panel, the mold is designed to receive at least a part of the glazing unit on which the rigid part will be inserted. It is understood that only the part of the glazing panel to be injected or the whole glazing panel can be inserted into the mold.

1. A window unit comprising:
a glazing panel;
a frame profile provided on an at least a part of an edge of the glazing panel on an at least one peripheral side and comprising a rigid part designed to receive a decorative strip the rigid part having an elongated shape with a long side along the at least one peripheral side, and comprising an at least a one rigid connection means and an at least one flexible connection means wherein the at least one rigid connection means and the at least one flexible connection means have an elongated shape with a long side along the at least one peripheral side and are an integral part of the rigid part; and
the decorative strip comprising an at least one first clamping part to be rotatably connected to the at least one rigid connection means and an at least one second clamping part to be clamped to the at least one flexible connection means wherein the at least one flexible connection means is totally offset from the at least one rigid connection means in a direction of the long side of the rigid part, by a distance greater than 0 mm (D>0 mm).

2. The window unit according to claim 1, wherein the distance is equal to or greater than 5mm (D≥5mm).

3. The window unit according to claim 1, wherein the at least one flexible connection means has an elasticity factor higher than 30 mm, the elasticity factor being defined as the square of the average length of an arm divided by the average thickness of the arm.

4. The window unit according claim 1, wherein the rigid part is made of a hard thermoplastic material with a Young modulus higher than 1000 Mpa.

5. The window unit according to claim 1, wherein the frame profile further comprises a soft part (6) made of a soft material, and being overmolded on an at least a part of the rigid part.

6. The window unit according to claim 5, wherein the soft material of the frame profile is made of a thermoplastic elastomer based material with a Young modulus lower than 1000 MPa.

7. The window unit according to claim 1, wherein the rigid part further comprises reinforcement means.

8. The window unit according to claim 1, wherein the rigid part further comprises torsion bars on each side of the rigid connection means.

9. The window unit according to claim 1, wherein the decorative strip further comprises a blocking strip.

10. A method for producing the window unit according to claim 1, the method comprising overmolding the rigid part provided on the at least a part of the edge of the glazing panel on an at least one peripheral side designed to receive the decorative strip the rigid part comprising the at least one rigid connection means and the at least one flexible connection means.

11. The method for producing the window unit according to claim 10, comprising:
placing a glazing in a first encapsulation mold or cavity;
encapsulating the rigid part on an at least one peripheral side of the glazing panel wherein the decorative strip is intended to be placed;
transferring the glazing and the rigid part so formed in a second encapsulation mold or cavity;
overmolding the at least a part of the rigid part by injection of the soft part and overmolding the at least one peripheral side of the glazing panel by injection of the soft part at the same time to form an injected module;
removing the injected module from the second encapsulation mold or cavity;
assembling the decorative strip on the injected module by rotatably connecting the first clamping part of the decorative strip to the at least one rigid connection means of the rigid part; and
clamping the second clamping part of the decorative strip to the at least one flexible connection means of the rigid part.

12. The method for producing a window unit according to claim 10, comprising:
injecting the rigid part in a separate mold;
placing a glazing and the rigid part in the first encapsulation mould;
encapsulating the soft part on at least one peripheral side of the glazing panel and overmolding the frame profile on at least a part of the rigid part wherein the decorative strip is intended to be placed, to form an injected module;
removing the injected module from the encapsulation mold;
assembling the decorative strip on the injected module by rotatably connecting the first clamping part of the decorative strip to the at least one rigid connection means of the rigid part; and
clamping the second clamping part of the decorative strip to the at least one flexible connection means of the rigid part.

13. A mold to produce the rigid part of the window unit according to claim 1, wherein the mold comprises a cavity to create by injection the rigid part that comprises the at least one rigid connection means and the at least one flexible connection means and wherein the at least one flexible connection means is totally offset from the at least one rigid connection means in the direction of the long side of the rigid part, by a distance greater than 0 mm (D>0 mm).

14. The window unit according to claim 1, wherein the distance is equal to or greater than 10mm (D≥10 mm).

15. The window unit according to claim 1, wherein the distance is equal to or greater than 15mm (D≥15 mm).

16. The window unit according claim 1, wherein the rigid part is made of a hard thermoplastic material with a Young modulus higher 1500 Mpa.

17. The window unit according claim 1, wherein the rigid part is made of a polypropylene based material.
